(19) United States
(12) Patent Application Publication
(10) Pub. No.: US 2012/0123816 A1
(43) Pub. Date: May 17, 2012

(54) SELECTING SUPPLIERS TO PERFORM SERVICES FOR AN ENTERPRISE

(76) Inventors: Xin Zhang, San Jose, CA (US); Shailendra K. Jain, Sunnyvale, CA (US); Jerry Z. Shan, Palo Alto, CA (US); Cipriano A. Santos, Modesto, CA (US); Jose Luis Beltran Guerrero, Palo Alto, CA (US)

(21) Appl. No.: 13/386,402

(22) PCT Filed: Mar. 13, 2010
(86) PCT No.: PCT/US10/27258

§ 371 Date: Jan. 20, 2012

(51) Int. Cl. G06Q 10/04

(52) U.S. Cl. 705/7.11

(57) ABSTRACT

One embodiment is a method that receives historical data of suppliers and applies, to the historical data, a mathematical optimization system that includes a set of mathematical equations and inequalities that express capabilities and capacities of the suppliers. The mathematical optimization system includes an objective function that minimizes a number of the suppliers to perform third-party labor services for an enterprise. The method selects a sub-set of the suppliers to perform the third-party labor services for the enterprise.

### FIELD OF THE INVENTION

The present invention relates to selecting suppliers to perform labor services for an enterprise.

### BACKGROUND

Companies often contract with third-party labor service providers or contractors to perform services for the companies. Third-party labor is used for a variety of reasons. For example, a company does not have the necessary technical skills to service an IT (information technology) infrastructure and hires an outside party to perform this servicing. Alternatively, it can be less expensive to sub-contract certain labor rather than perform the same labor with in-house employees. Further, demand for some specialized skills is highly uncertain (for instance, a company is not certain whether it will attain a contract requiring a large workforce of skilled laborers). Therefore, the company may elect not to keep a regular workforce that includes employees with such specialized skills.

To meet labor demands, a large company can have hundreds or even thousands of contractors that provide unique skills for the company or its customers. Selecting one or more contractors to effectively and efficiently perform services can be challenging even if such contractors previously performed services for the company. A third-party labor service provider often has skilled laborers with multiple different skills. Such providers also have varying degrees of labor capabilities (for example, the number of available skilled laborers varies among different labor service providers), different cost structures, different amounts of labor volume that can be contracted, etc.

### BRIEF DESCRIPTION OF THE DRAWINGS

FIG. 1 is a table illustrating money spent by an enterprise for labor suppliers in accordance with an example embodiment.

FIG. 2 is a bipartite graph illustrating a relationship between suppliers and capabilities in accordance with an example embodiment.

FIG. 3 is a flow diagram of a two-stage process for solving supplier consolidation and cost minimization problems in accordance with an example embodiment.

FIG. 4 is a table showing capacity factors of suppliers that supply labor to an enterprise in accordance with an example embodiment.

FIG. 5 is a flow chart showing a solution to a supplier consolidation problem in accordance with an example embodiment.

FIG. 6 shows a computer system for implementing processes in accordance with an example embodiment.

### SUMMARY OF THE INVENTION

One embodiment is a method that receives historical data of suppliers and applies, to the historical data, a mathematical optimization system that includes a set of mathematical equations and inequalities that express capabilities and capacities of the suppliers. The mathematical optimization system includes an objective function that minimizes a number of the suppliers to perform third-party labor services for an enterprise. The method selects a sub-set of the suppliers to perform the third-party labor services for the enterprise.

### DETAILED DESCRIPTION

Example embodiments relate to apparatus and methods that identify capable suppliers and consolidate a supplier base for an enterprise. One example embodiment identifies third-party labor service providers (i.e., suppliers), among a large list of suppliers with whom an enterprise has previously done business, for supplying labor services to the enterprise or its customers.

When unit cost data of each supplier is available, an example embodiment selects suppliers to minimize a total procurement cost paid by the enterprise. As used herein and in the claims, the word “enterprise” is a unit of economic organization, such as a business or company. In selecting one or more suppliers, this embodiment considers one or more of supplier capacity or capability category (for example, the number and skill level of available laborers at each of the suppliers), supplier share limit (for example, the volume of services each supplier can provide to the enterprise), and a variety of other business factors. As used herein and in the claims, the word “supplier” is an individual, organization, or company that supplies or provides labor services to an enterprise. For example, an enterprise contracts with a supplier to outsource services to customers of the enterprise. The supplier provides workers that perform labor services for the enterprise.

Example embodiments reduce an overall cost in identifying and selecting suppliers for contract labor services that will be performed for an enterprise. When a large group of different suppliers is available, the suppliers are consolidated and categorized based on multiple skills offered to the enterprise and volume or amount of skills available. Consolidation of suppliers is stored or provided in a new or updated Approved Supplier List (ASL).

In order to select a minimum number of suppliers at a lowest cost, a mathematical optimization model is used to show that a given number of suppliers (for example, supplier 1, supplier 2, . . . supplier N) are feasible for performing designated tasks. Example embodiments provide both a minimum number of suppliers to provide sufficient labor for tasks in various categories of work, but also select suppliers that will perform the labor at a lowest cost. Further, the labor services are distributed among multiple suppliers to limit risk that one of the suppliers will not complete the requested labor services. This distribution can be provided as a list or recommendation.

In one example embodiment, the optimization model minimizes the number of suppliers that collectively cover the projected spending in the labor categories. At the same time, the model selects the number so as to not exceed individual supplier's capacities in any of the labor categories determined from historical data and not to exceed a policy limit on the maximum percentage of the total spend in a category that is awarded to any individual supplier. The optimization model performs this selection by expressing the individual supplier capacities and risk policy limits as a set of mathematical equations and inequalities (e.g., with a software solver that is applied to find numerical solutions to this set of mathematical expressions).

By expressing the selection problem as a set of mathematical expressions, one example embodiment obtains a systematic method of determining a supplier's “worth” (or value or weight) by considering the individual supplier's historical performance in various labor categories. Furthermore, a supplier's “worth” is determined relative to all other suppliers' historical performance. For example, a supplier that is capable of performing $3M (annually) labor services in a single category may be less “worthy” than another supplier that is capable of performing $1M (annually) labor services in two different categories.

The mathematical optimization model determines valued suppliers collectively (as opposed to one-by-one, i.e. iteratively). Example embodiments further determine the conditions under which the set of mathematical equations and inequalities will lead to at least one feasible (and optimal) numerical solution (i.e., the conditions under which there is indeed a subset of suppliers that satisfy all the constraints on individual supplier capacities and enterprise policy limits.)

Example embodiments are explained in a context wherein an enterprise or company hires or contracts one or more third-party (3P) labor services providers (i.e., suppliers) to provide services for the enterprise or its customers. These suppliers include suppliers with whom the enterprise previously hired or contracted for labor services. Data about past work of previous suppliers is recorded and retained. For example, this data includes an amount of money the enterprise spent to hire labor services of the suppliers, specializations of skills that the suppliers have in different labor categories, and capacities of the suppliers to provide labor to the enterprise in the different labor categories. Thus, example embodiments store financial data and data on capabilities and specializations for each supplier. By way of example, this information includes labor capabilities or skills categories and labor capacity for each supplier. Here, the term “capability” is used to express the number of labor (skill) categories a supplier is capable of supplying; and the term “capacity” is used to express the dollar volume of business in a given labor (skill) category. Thus, capability is an integer (number of categories) while capacity is a dollar figure.

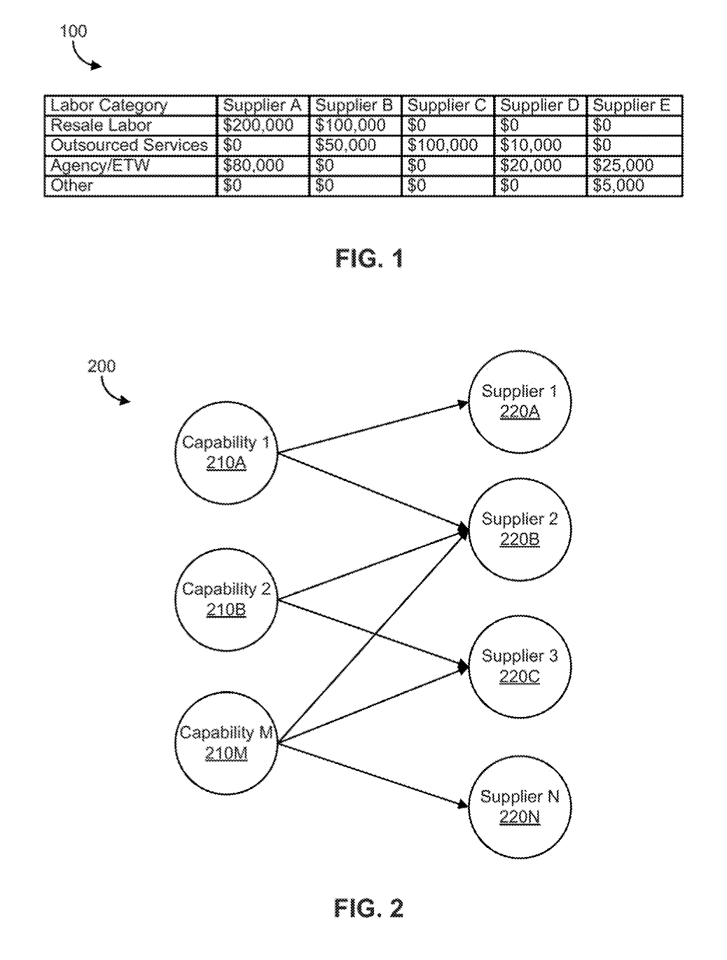

FIG. 1 is a table 100 illustrating money spent by an enterprise for labor suppliers in accordance with an example embodiment. The table show how much money the enterprise spent to contract for services with five suppliers (supplier A to supplier E) in four different labor categories (resale labor, outsourced services, agency, and other).

FIG. 2 is a bipartite graph 200 illustrating a relationship between suppliers (shown as supplier 1 (220A), supplier 2 (220B), supplier 3 (220C), to supplier N (220N)) and capabilities (shown as capability 1 (210A), capability 2 (210B), to capability M (210M)) in accordance with an example embodiment.

Given a group of available suppliers for given tasks, example embodiments consolidate these suppliers into a subset of suppliers that are best suited or most capable or likely of providing the best performance of requested labor services for the enterprise. Given (1) the suppliers-to-capabilities matrix (with dollar volumes of business), or the suppliers-to-capabilities graph (with dollar volumes as weights of the arcs), and (2) a capacity factor with which each supplier is able to increase their dollar volume of business with the enterprise (for example, a capacity factor of 2.0 for a supplier in a capability category would mean that the supplier can double its dollar volume of business in that category), an example embodiment determines subset of capable suppliers. Here, the term “capable” means suppliers that can timely provide the labor skills and dollar volumes of business to the enterprise or its customers. The capacity factor in general is specific to a supplier and a capability category; thus a supplier can have a capacity factor of 2.0 in one category but only 1.5 in another category.

Consolidation of the suppliers into a subset is solved using mathematical modeling. If the business volumes are disregarded and capacities are analyzed (i.e., the edges of the bipartite graph are examined while disregarding the weights on the edges), then a solution is generated by solving a set covering problem. Disregarding the business volumes (edge weights) is equivalent to assuming that the capacity factor is equal to infinity. In this sense, a mathematical problem being solved is a capacitated version of the set covering problem.

The set covering problem provides a lower bound to a minimum number of suppliers required. Furthermore, the minimum number of suppliers required is a non-increasing function in each of the capacity factors.

In a business context of third-party (3P) labor procurement, the above capacitated set covering problem arises due to any of various reasons (three example reasons being discussed below).

A first reason is capability (specialization). Some suppliers are not capable of providing a specific category of labor. For example, some repair services specialize in equipment of company A but not products of company B. However, a reasonable assumption is that if a supplier has provided labor in a particular labor category in the past, then the supplier is capable of providing labor in the same category in the future.

A second reason is capacity limit. Even if a supplier is capable of providing labor in a category, the supplier may not be able to supply all the labor requirements of the enterprise in that category. Given the market position and size of some enterprises, a supplier could be overwhelmed by the enterprise's business volume in a category.

A third reason is procurement policy considerations of the enterprise. Even if a supplier is capable and is large enough to provide all third-part labor requirements in a country and in a category for an enterprise, supplying such services from a single supplier may not be optimal. From the perspective of the enterprise, an overly large amount of procurement risk is associated with a single supplier. Furthermore, the enterprise can have policy constraints. For example, in some business critical categories, the enterprise can require that the business unit outsource to at least two suppliers. Diversifying and distributing the labor to multiple suppliers effectively limits the share of any supplier of the enterprise's demand to less than strictly 100% and limits a risk that one of the suppliers will not complete requested labor services.

As discussed more fully below, example embodiments also select a supplier with minimal or optimal costs to the enterprise. When the forward unit cost data is available (in addition to the capability and capacity data about the suppliers), an example embodiment selects the suppliers and allocates the category demands among the selected suppliers to minimize the third-party labor procurement cost to the enterprise.

One example embodiment utilizes a mathematical optimization approach with two stages for procurement optimization. A first objective is to minimize a number of suppliers, and a second objective is to minimize total cost. A solution to the first objective (first stage) provides an input to the second stage (through a relaxation factor).

This two-staged approach uses a small amount of input data—the bulk of the input data used for a supplier consolidation model is the historical spend h(i, j), while other data F(i) is aggregated from h(i, j); and the capacity factors C(i, j) and supplier share limits r(i) are parameterized as sensitivity analysis scenarios. In use cases where the decision maker does not have additional data such as unit cost per hour or supplier hours available to him or her, at least the first stage for supplier consolidation can be executed.

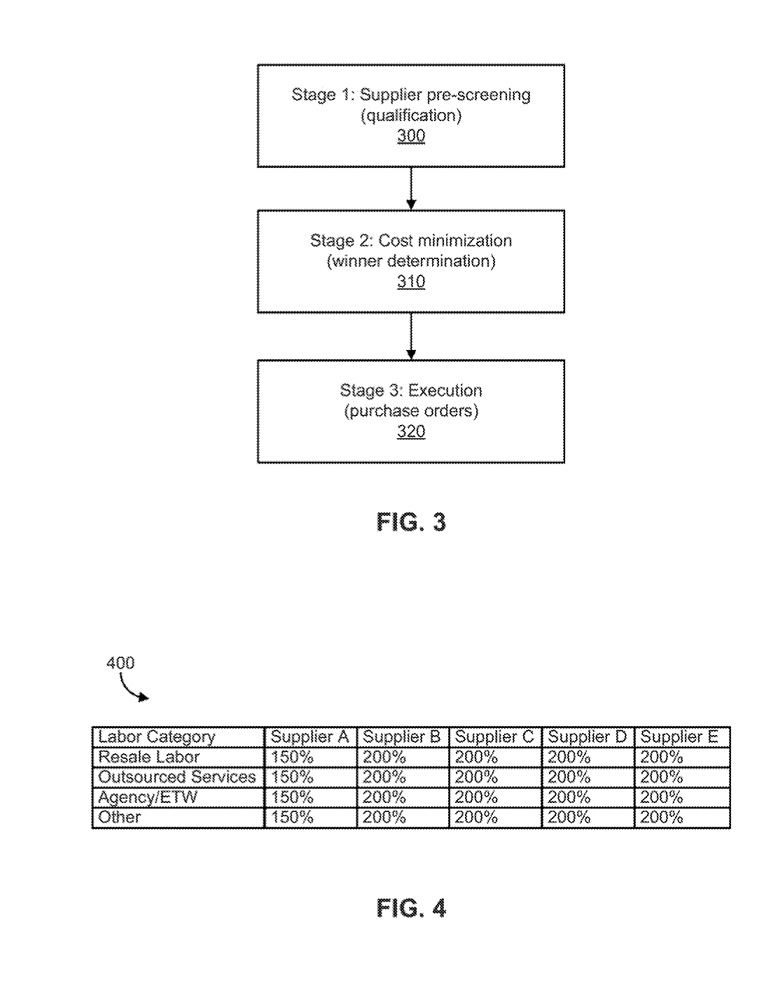

FIG. 3 is a flow diagram of a two-stage process for solving supplier consolidation and cost minimization problems in accordance with an example embodiment.

According to block 300, supplier pre-screening or supplier qualification occurs. This stage minimizes a number of suppliers using various input data, such as historical business data with suppliers in different categories, capacity factors for the suppliers, strategic partners desired by the enterprise, and policies and constraints designated by the enterprise.

According to block 310, cost minimization and winner determination occur. This stage minimizes a total cost to the enterprise. Requests for quotes (RFQs) are sent to various suppliers to solicit bids (rates and costs) for labor services desired by the enterprise. Selected or winning suppliers enter into contracts with the enterprise to supply the requested labor services.

According to block 320, execution or purchase orders occur. Here, the suppliers perform the services for the enterprise and/or its customers.

In the first stage, the supplier consolidation is determined, and the number of supplies is minimized. In the second stage, the cost minimization is determined, and the total cost is minimized. Stage 1 is used as a “pre-screening device” for qualifying suppliers before the auction/RFQ stage. The “qualified” suppliers are then contacted for bids that include forward unit costs. In stage 2, cost minimization is run to select the final winners.

In one example embodiment, the stages are linked. Consolidation is solved under a set of capacity factors, while ignoring the costs, to obtain the minimum number of suppliers needed (for example, 80 suppliers are selected from several hundred potential suppliers). The output from the first stage (i.e., the 80 suppliers) is combined with additional user input for a “consolidation relaxation factor” (for example, 1.5), to set a constraint which stipulates that the total number of suppliers selected in the second stage cannot be more than 80×1.5=120. The second stage then minimizes the total costs.

In stage 1, an example embodiment uses a mathematical optimization approach by formulating a mixed integer linear programming (MIP) model which consists of an objective function and a set of constraints expressed as equalities (equations) and inequalities. In the first stage (supplier consolidation), considerations include the supplier capability, capacity, and enterprise business policy on supplier share as constraints. In the second stage, the “relaxed number of suppliers” (which is equal to the minimum number of suppliers from stage 1 multiplied by a relaxation factor) is used as an additional constraint.

To formulate the mathematical optimization model, various assumptions (discussed below) are made to illustrate an example embodiment.

The supplier capability is indicated by historical (for example past 12 months) business with the enterprise. To be specific, if a supplier has supplied labor to the enterprise in a particular labor category in the past 12 months, this supplier will be able to continue to supply labor in the same category. If a supplier has not supplied labor to the enterprise in a particular labor category in the past, then this supplier will not be able to supply labor in that category in the future.

Furthermore, capacity of a supplier is based on historical (past 12 months) spending of the enterprise with the supplier and a capacity factor going forward. As an example, FIG. 4 is a table showing capacity factors of suppliers that supply labor to the enterprise. The table 400 shows how much each supplier is able to supply labor in the future, and this capacity is shown as a percentage of the supplier's past business volume with the enterprise.

The capacity limits expressed as percentages are not uniform across all suppliers or all labor categories. For example, a larger supplier might have a smaller percentage (for example, 150%) than a smaller supplier (for example, 200%). This difference reflects an assumption that it is more difficult for the larger supplier to double its capacity than a smaller supplier. In addition, if the supply of a particular labor category is scarce in a country, then the capacity limit of the labor category should be lower than other labor categories. Finally, the decision maker may decide to reduce or even eliminate one supplier from future consideration for doing business. In this instance, the capacity limit of the supplier is set to be a value less than 100% or to 0%.

Should a supplier be eliminated, its future business volume with the enterprise (as derived from the historical spending) can be split in any way to other suppliers. This assumption effectively permits third-party labor demand to be aggregated across all suppliers in a category to form a “category demand” (i.e., the row sum in the historical spend matrix), then allocate the category demand to any single or multiple suppliers.

Discussion is now directed to the optimization model for solving the supplier consolidation problem. To describe this model, the following notation is introduced:

i: Labor category (corresponding to the row number in the historical spend matrix, and the row number in the supplier capacity matrix). The labor categories are numbered from 1 through m.

j: Supplier (corresponding to the column number in the historical spend matrix). The suppliers are numbered from 1 through n.

h(i, j): Historical spend (in dollars) of supplier j in category i. This matrix is an input data.

F(i): Forecasted spending (in dollars) in category i, over all suppliers. This vector is an input data. The forecasted spending is equal to the aggregated historical spend as follows:

$$F ( i ) = {\sum }_{j = 1}^{a} h ( i , j ) .$$

However, the decision maker is able to adjust the forward-looking spending at the labor category level, so F(i) is greater than the following:

$${\sum }_{j = 1}^{n} h ( i , j )$$

if the decision maker can foresee an increasing of spending in a category i. For categories in which the enterprise is exercising tighter cost controls, F(i) may be less than the following:

$${\sum }_{j = 1}^{n} h ( i , j ) .$$

C(i, j): Supplier capacity (in multiples such as 1.5) of supplier j in category i. This is input data.

y(j)=0 or 1: Decision variable indicating whether supplier j will be used after consolidation.

x(i, j)=amount of forecasted spend (in dollars) in category i that is allocated to supplier j (after the consolidation).

The objective function is to minimize the total number of suppliers after consolidation:

$$Minimize {\sum }_{j = 1}^{n} y ( j ) . \qquad ( 1 )$$

The first constraint is that demand in each category is met:

$${\sum }_{j = 1}^{n} x ( i , j ) = F ( i ) , for all i = 1 , 2 , … , m . \qquad ( 2 )$$

The second constraint is logical: Allocate to a supplier if the supplier is chosen (otherwise do not allocate), and the allocation amount cannot exceed the supplier's capacity:

x(i,j)≦C(i,j)h(i,j)y(j), for all i=1,2, . . . ,m, and all j=1,2, . . . ,n. (3)

Consideration is also given to the allocation of the total spend in a labor category among the consolidated suppliers. It may be desirable to enforce a “balanced sourcing” policy for mitigating risk to the enterprise that the labor services will not be completed. This supplier risk limits the total share of any supplier of the enterprise's demand in any category. For example, suppose the enterprise has a policy to not have any single supplier for taking more than 70% of the enterprise's total outsourced business in some specific labor category i. This policy leads to the following:

x(i,j)≦r(i)·F(i), for all i=1,2, . . . ,m, and all j=1,2, . . ., n. (4)

Here, the maximum supplier share in category i is r(i)=0.7 (the default value is r(i)=1, for those categories i which do not enforce a supplier share upper limit).

Combining the supplier capacity constraints (3) and supplier share constraints (4), the following upper bound for decision variables x(i, j) is obtained:

x(i,j)≦U(i,j)≡min {C(i,j)h(i,j), r(i)·F(i)}, for all i=1,2, . . . ,m, and all j=1,2, . . . ,n.

An example embodiment can exclude, a priori, some suppliers from consideration. In this case, let E be the set being excluded; then set y(j)=0 and x(i, j)=0 for every j∈E. Similarly, it is possible to fix, a priori, a set of suppliers to be among the chosen ones. In that case, set y(j)=1 for every j∈I where I is the set of fixed suppliers.

Discussion is now directed to feasibility conditions of the optimization model for supplier consolidation.

Consider the conditions under which the resulting optimization system consisting of the objective function (1) and constraints (2), (3), and (4) is feasible. Since the objective function has a lower bound of zero, the optimization problem will have an optimal solution if the problem is feasible (the problem will not have an unbounded solution).

Any of the following three conditions can potentially make the optimization problem infeasible: (a) small capacity factors C(i, j); or (b) excluded suppliers E; or (c) low supplier share limits r(i). The set of pre-determined suppliers/does not cause any feasibility problems.

The following proposition provides a sufficient condition for the optimization problem (1), (2) and (3) to be feasible when the set E (of excluded suppliers) is not empty.

Proposition 1. If suppliers j∈E are excluded, and the supplier share constraint (4) is not imposed, then the optimization system consisting of (1), (2), and (3) is feasible if and only if the following inequality holds:

$${\sum }_{j ∉ E} C ( i , j ) h ( i , j ) \geq F ( i ) , for all i = 1 , 2 , … , m . \qquad ( 5 )$$

Proof. We first prove that if the above inequality holds, then the system (1), (2), and (3) has at least one feasible solution. Let

$$k ( i ) ≡ \frac{F ( i )}{{\sum }_{j ∉ E} C ( i , j ) h ( i , j )} , for all i = 1 , 2 , … , m .$$

Inequality (5) implies that k(i)≦1 for all i. Now, we show that the “pro-rated” solution x⁰(i, j)=k(i)·C(i, j) h(i, j) for j∉E, and y⁰(j)=1 for j∉E, and x⁰(i, j)=y⁰(j)=0 for j∈E, is a feasible solution. First, consider constraint (2):

$$\begin{matrix}{\sum }_{j = 1}^{n} {x}^{0} ( i , j ) = {\sum }_{j = 1}^{n} k ( i ) C ( i , j ) h ( i , j ) \\ = k ( i ) {\sum }_{j = 1}^{n} C ( i , j ) h ( i , j ) \\ = k ( i ) {\sum }_{j ∉ E} C ( i , j ) h ( i , j ) \\ = F ( i ) ,\end{matrix}$$

$$for all i = 1 , 2 , … , m .$$

where the last equality is due to the definition of k(i). Hence constraint (2) is satisfied. It is easy to see that constraint (3) is satisfied, since

x⁰(i,j)=k(i)C(i,j)h(i,j)=C(i,j)h(i,j)y⁰(j) for j∈E,

x⁰(i,j)=0=C(i,j)h(i,j)y⁰(j) for j∈E.

Now we prove that if the system (1), (2) and (3) is feasible, then inequality (5) holds. Let x⁰(i, j) and y⁰(j) be a feasible solution where x⁰(i, j)=y⁰(j)=0 for j∈E,

then constraint (3) is satisfied:

x⁰(i,j)≦C(i,j)h(i,j)y⁰(j), for all i=1,2, . . . ,m, and all j=1,2, . . . ,n.

Summing over j on both sides of the above inequality, the following is obtained:

$${\sum }_{j ∉ E} {x}^{0} ( i , j ) \leq {\sum }_{j ∉ E} C ( i , j ) h ( i , j ) {y}^{0} ( j ) , for all i = 1 , 2 , … , m .$$

By constraint (2), the following occurs:

$$F ( i ) = {\sum }_{j ∉ E} {x}^{0} ( i , j ) \leq {\sum }_{j ∉ E} C ( i , j ) h ( i , j ) {y}^{0} ( j ) \leq {\sum }_{i ∉ E} C ( i , j ) h ( i , j ) , \\ for all i = 1 , 2 , … , m .$$

Hence inequality (5) holds. End of proof.

This line of reasoning is extended to the system requiring that no supplier exceed a pre-specified limit r(i) of the total demand in category i. The proof is similar to that of Proposition 1.

Proposition 2. If suppliers j∈E are excluded, and the supplier share constraint (4) is imposed, then the resulting optimization system consisting of (1), (2), (3) and (4) is feasible if and only if the following inequality holds:

$${\sum }_{j ∉ E} min \{ C ( i , j ) h ( i , j ) , r ( i ) \cdot F ( i ) \} ≡ {\sum }_{j ∉ E} U ( i , j ) \geq F ( i ) , \\ for all i = 1 , 2 , … , m . \qquad ( 6 )$$

Proof. We prove that if the above inequality holds, then the system (1), (2), (3) and (4) has at least one feasible solution. Let

$$k ( i ) ≡ \frac{F ( i )}{{\sum }_{j ∉ E} U ( i , j )} , for all i = 1 , 2 , … , m .$$

Inequality (6) implies that k(i)≦1 for all i. Now, we show that the “pro-rated” solution x⁰(i, j)=k(i)·U(i, j), and y⁰(j)=1 for j∉E, and x⁰(i,j)=y⁰(j)=0 for j∈E, is a feasible solution. First, consider constraint (2):

$${\sum }_{j = 1}^{n} {x}^{0} ( i , j ) = {\sum }_{j ∉ E} {x}^{0} ( i , j ) = {\sum }_{j ∉ E} k ( i ) U ( i , j ) = k ( i ) {\sum }_{j ∉ E} U ( i , j ) = F ( i ) , \\ for all i = 1 , 2 , … , m .$$

Hence constraint (2) is satisfied. Constraint (3) is satisfied, since for j∉E,

x⁰(i,j)=k(i)U(i,j)≦U(i,j)=min{C(i,j)h(i,j), r(i)·F(i)}≦C(i,j)h(i,j)=C(i,j)h(i,j)y⁰(j)

Constraint (4) is similarly satisfied, since ford j∉E,

x⁰(i,j)=k(i)U(i,j)≦U(i,j)=min{C(i,j)h(i,j), r(i)·F(i)}≦r(i)·F(i).

Now we prove that if the system (1), (2), (3) and (4) is feasible, then inequality (6) holds. Let x⁰(i, j) and y⁰(j) be a feasible solution where x⁰(i, j)=y⁰(j)=0 for J∈E, then from constraint (3) and constraint (4), the following occurs:

x⁰(i,j)≦min {C(i,j)h(i,j), r(i)·F(i)}=U(i,j), for all i=1,2, . . . ,m, and all j=1,2, . . . ,n.

Summing over j on both sides of the above inequality, the following is obtained:

$${\sum }_{k ∉ E} {x}^{0} ( i , j ) \leq {\sum }_{j ∉ E} U ( i , j ) , for all i = 1 , 2 , … , m .$$

By constraint (2), we have

$$F ( i ) = {\sum }_{j ∉ E} {x}^{0} ( i , j ) \leq {\sum }_{j ∉ E} U ( i , j ) , for all i = 1 , 2 , … , m .$$

Hence inequality (6) holds. End of proof.

Conditions (5) and (6) for feasibility can be reduced to simpler expressions under some special cases. For example, when (1) no suppliers are excluded a priori, and (2) the forecasted category demand F(i) is equal to the (aggregated) historical spend

$${\sum }_{j = 1}^{n} h ( i , j ) ,$$

and (3) no supplier share limit is in force, then the system consisting of (1), (2) and (3) will be feasible if all capacity factors C(i, j)≧1, since in this case inequality (5) is satisfied.

With the results above, the optimization model is rewritten as follows:

$$Minimize {\sum }_{j = 1}^{n} y ( j ) \qquad ( 1 )$$

Subject to:

$$\begin{matrix}{\sum }_{j ∉ E} x ( i , j ) = F ( i ) , \\ for all i = 1 , 2 , … , m . & ( {2}^{′} ) \\ x ( i , j ) \leq U ( i , j ) y ( j ) , \\ for all i = 1 , 2 , … , m , \\ and all j ∉ E ⋃ I . & ( 3 a ) \\ 0 \leq x ( i , j ) \leq U ( i , j ) , \\ for all i = 1 , 2 , … , m , \\ and all j ∉ E . & ( {4}^{′} ) \\ y ( j ) = 0 or 1 , \\ for all j ∉ E ⋃ I . & ( 5 a ) \\ y ( j ) = 0 , \\ for all j ∈ E ; x ( i , j ) = 0 , \\ for all i = 1 , 2 , … , m , \\ and all j ∈ E . & ( 5 b ) \\ y ( j ) = 1 , \\ for all j ∈ I . & ( 5 c )\end{matrix}$$

where U(i,j)≡min {C(i,j)h(i,j), r(i)·F(i)}

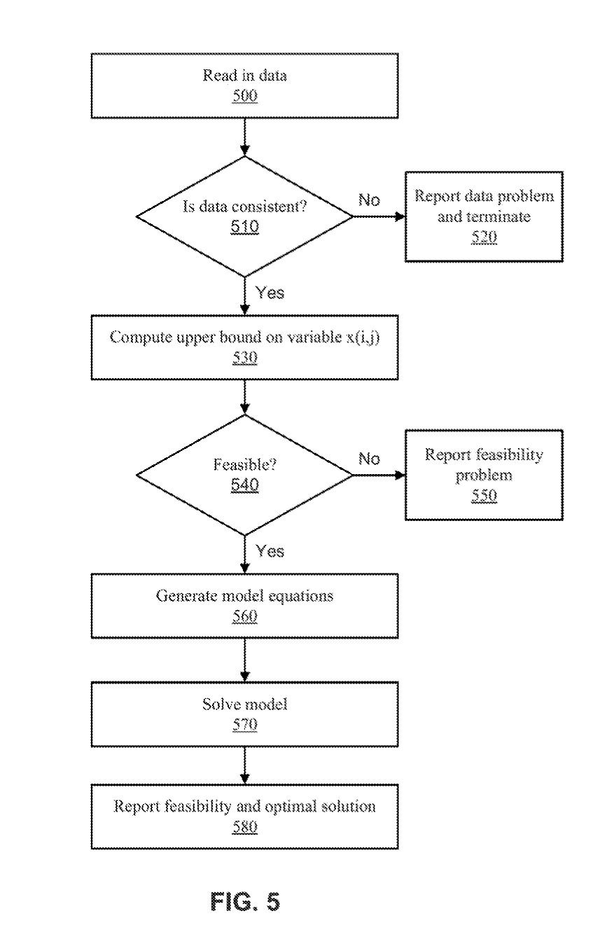

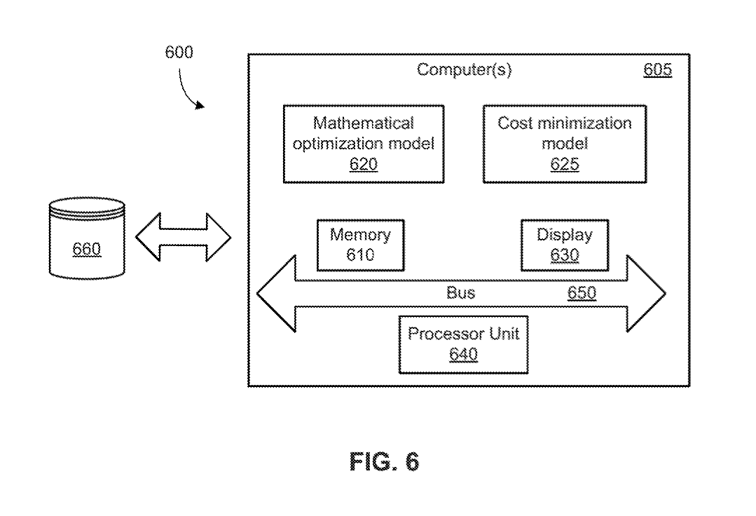

FIG. 5 is a flow chart showing a solution to the supplier consolidation problem in accordance with an example embodiment. FIG. 5 is discussed in connection with FIG. 6 which shows a computer system 600 for implementing example embodiments.

The computer system includes one or more storage devices, databases, or warehouses 660 coupled to one or more computers or servers 605. By way of example, the computer 605 includes memory 610, a mathematical optimization model 620, a cost minimization model 625, display 630, processing unit 640, and one or more buses 650. The processor unit includes a processor (such as a central processing unit, CPU, microprocessor, application-specific integrated circuit (ASIC), etc.) for controlling the overall operation of memory 610 (such as random access memory (RAM) for temporary data storage, read only memory (ROM) for permanent data storage, and firmware). The processing unit 640 communicates with memory 610 and models 620 and 625 via one or more buses 650 and performs operations and tasks necessary for identifying and selecting suppliers as explained herein. The memory 610, for example, stores applications, data, programs, algorithms (including software to implement or assist in implementing embodiments in accordance with the present invention) and other data.

According to block 500, data is read in, such as data from storage device 660. By way of example, this data includes, but is not limited to, one or more of the following:
(1) Set of suppliers i and set of categories j.
(2) Historical spend of supplier j in category i, matrix h(i, j).
(3) Supplier capacity factor C(i, j).
(4) Forecasted category demand F(i)
(5) Limit of supplier share in category i, r(i).
(6) The set of excluded suppliers, E.
(7) The set of included (pre-determined) suppliers I.

According to block 510, a determination is made as to whether the data is consistent. For example, the following consistency checks are performed:
(1) Is every h(i, j)≧0?
(2) Is every r(i)≧0?
(3) Is E∩I=φ?

If the data is not consistent, then flow proceeds to block 620 wherein a data problem is reported and flow terminated. For example, a user or computer 605 is notified, such as through a display message, generation of a report, text message, email, etc.

If the data is consistent, then flow proceeds to block 530 wherein an upper bound is computed for variable x(i, j). Here, the following is computed:

U(i,j)≡min {C(i,j)h(i,j), r(i)·F(i)}.

According to block 540, a feasibility determination is made. For example, the following determination is made:

$$Is {\sum }_{j ∉ E} U ( i , j ) \geq F ( i ) , for all i = 1 , 2 , … , m ?$$

If the answer to this determination is “no” then flow proceeds to block 550 and a feasibility problem is reported and flow terminates. For example, a recommendation is provided as “increase capacity factors, C(i,j) or supplier share limits r(i).” For example, a user or computer is notified, such as through a display message, generation of a report, text message, email, etc.

If the answer to the determination is “yes” then flow proceeds to block 560 and the model equations are generated. For example, the mathematical optimization model 620 generates the equations (1), (2′), (3a), (4′), (5a), (5b), and (5c).

According to block 570, the model is solved by the mathematical optimization model 620. For example, a mixed integer linear (MIP) solver is used.

According to block 580, feasible and optimal solutions are reported and stored. For example, a user or computer 605 is notified, such as through a display message, generation of a report, text message, email, etc.

In one example embodiment, the mathematical optimization model 620 includes a cost minimization model 625. This cost minimization model has one example objective to minimize the (planned) total cost of procurement from the suppliers. Suppose the unit cost per hour from supplier i for labor category j is u(i, j). Previous input data, historical supplier business volume h(i, j), and category demand F(i) are all measured in labor hours (previously they are given in dollars). As a result, the supplier capacity factors C(i, j) and the supplier share limit r(i) all apply on the basis of labor hours rather than dollars; the demand variables x(i, j) are now expressed in hours rather than dollars.

The cost optimization model 625 is as follows:

$$Minimize {\sum }_{i = 1}^{m} {\sum }_{j ∉ E} u ( i , j ) \cdot x ( i , j ) . \qquad ( K1 )$$

This model is subject to:

$$\begin{matrix}{\sum }_{j ∉ E} x ( i , j ) = F ( i ) , \\ for all i = 1 , 2 , … , m . & ( K2 ) \\ x ( i , j ) \leq U ( i , j ) y ( j ) , \\ for all i = 1 , 2 , … , m , \\ and all j ∉ E ⋃ I . & ( K3 ) \\ 0 \leq x ( i , j ) \leq U ( i , j ) , \\ for all i = 1 , 2 , … , m , \\ and all j ∉ E . & ( K4 ) \\ y ( j ) = 0 or 1 , \\ for all j ∉ E ⋃ I . & ( K5a ) \\ y ( j ) = 0 , \\ for all j ∈ E ; x ( i , j ) = 0 , \\ for all i = 1 , 2 , … , m , \\ and all j ∈ E . & ( K5b ) \\ y ( j ) = 1 , for all j ∈ I . & ( K5c ) \\ {\sum }_{j ∉ E} y ( j ) \leq R \cdot {Z}_{1} & ( K6 )\end{matrix}$$

where U(i,j)≡min {C(i,j)h(i,j), r(i)·F(i)}.

Constraints (K2) through (K5c) are the same as in the supplier consolidation problem. The new constraint (K6) limits the number of suppliers selected in cost minimization to be no more than R times that from the minimum number of suppliers, Z₁, obtained from the supplier consolidation solution. This constraint links the two problems. R is a “relaxation factor” (whose value is greater than 1). The user (decision maker) inputs a value for R (typically R=1.5). The higher the value of R, the greater the freedom in cost minimization (thus the lower the total cost), but the greater the number of suppliers selected. The user can perform a scenario analysis Of the total cost based on different values of R.

As one procurement option to select suppliers, the enterprise can examine the list of suppliers and the total amount the enterprise has spent on each supplier aggregated over all the labor categories. Then, the suppliers are rank-ordered from largest to smallest based on the amount spent by the enterprise, and the top K suppliers are designated as ASL.

Embodiments in accordance with the invention expand this procurement option in a number of different aspects.

First, an example embodiment provides consideration of both volume and specialization (skills) of each supplier. The procurement option described above considers or analyzes volume but does not consider or analyze the supplier specialization in different labor categories. By accepting a matrix input of volume and category h(i, j), an example embodiment solves a two-dimensional ranking problem. The example embodiment thus analyzes both an amount of money the enterprise historically spent on each of the suppliers (or volume of work) and specializations of each of the suppliers in different labor categories.

Second, an example embodiment considers the capacity of the supplier. Supplier consolidation results in some suppliers getting a greater share of the enterprise's business (and other suppliers getting 0 share). For a small-sized supplier, doubling business volume with the enterprise might be difficult to achieve in a short time (i.e., the enterprise could potentially overwhelm a supplier). This situation can occur when the supplier needs to hire additional skilled professionals, and hiring lead times can be long (job posting, interviewing, offer acceptance, on-boarding, etc.).

Third, an example embodiment considers the procurement risk to the enterprise. Consideration is given to the minimum number of suppliers for any labor category, so as to control for procurement risk.

Additionally, a number of factors can be included into the optimization model. By way of example, these factors include, but are not limited to, the following:
(1) Minimum business volume for specific suppliers (such as $100,000);
(2) N-choose-K: Out of a sub-group of N suppliers (the sub-group can be geographical, or by industry sections such as financials, government, manufacturing, etc), choose at least (or alternative, at most) K of them; and
(3) Targeted (desired) number of suppliers (such as “80 suppliers in country XYZ” or “50% reduction in number of suppliers”).

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit the invention.

In some example embodiments, the methods illustrated herein and data and instructions associated therewith are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the various embodiments in accordance with the present invention, embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
receiving historical data of suppliers;
applying, by the computer and to the historical data, a mathematical optimization system including a set of mathematical equations and inequalities that express capabilities and capacities of the suppliers and including an objective function that minimizes a number of the suppliers to perform third-party labor services for an enterprise; and
selecting, by the computer, a sub-set of the suppliers to perform the third-party labor services for the enterprise.

2) The method of claim 1 further comprising, analyzing, by the mathematical optimization system, amounts of historical spending of the enterprise on multiple labor categories for each of the suppliers to determine labor categories for which the suppliers are capable of performing.

3) The method of claim 1 further comprising, analyzing, by the mathematical optimization system, amounts of historical spending of the enterprise on multiple labor categories for each of the suppliers to determine capacity of the suppliers expressed in dollars for performing services in each of the multiple labor categories.

4) The method of claim 1 further comprising, expressing, by the mathematical optimization system, the capabilities of the suppliers, the capacities of the suppliers, and procurement risk control policies of the suppliers to ensure that capacities of each supplier in a labor category remain within a range.

5) The method of claim 1 further comprising, expressing, by the mathematical optimization system, the capabilities of the suppliers, the capacities of the suppliers, and procurement risk control policies of the suppliers to ensure that a policy limit is adhered to, the policy limit defining a maximum percentage of total money spent on any category.

6) The method of claim 1, wherein the historical data includes a list of suppliers that performed third-party labor services for the enterprise, a list of categories that indicate skills and competencies of the suppliers, and a business transaction volume expressed in dollar amount, or hours worked, or work units and pieces, of the suppliers in each labor category.

7) The method of claim 1 wherein the set of mathematical equations and inequalities include constraints having at least one of (i) meeting forecasted future spending amounts in each of multiple labor categories; (ii) not exceeding capacities of each of the suppliers in each of the multiple labor categories; and (iii) not exceeding a maximum percentage of total spending in a category awarded to any single supplier.

8) A tangible computer readable storage medium having instructions for causing a computer to execute a method, comprising:
identifying historical data of suppliers;
analyzing the historical data with a mathematical optimization model that includes a set of constraints having equations and inequalities that express capabilities and capacities of the suppliers and an objective function that minimizes a total procurement cost to perform third-party labor services for an enterprise; and
selecting a sub-set of the suppliers to perform the third-party labor services for the enterprise.

9) The tangible computer readable storage medium of claim 8, wherein the mathematical optimization model analyzes factors that include an amount of money the enterprise spent to hire labor services of the suppliers, specializations of skills that the suppliers have in different labor categories, and capacities of the suppliers to provide labor to the enterprise in the different labor categories.

10) The tangible computer readable storage medium of claim 8 having instructions for causing the computer to further execute the method for: identifying a minimum number of the suppliers to perform sufficient labor to complete tasks for the enterprise in each of different labor categories, and identifying a minimum number of the suppliers to perform the third-party labor services at a lowest cost.

11) The tangible computer readable storage medium of claim 8 having instructions for causing the computer to further execute the method for, distributing labor services to multiple suppliers to limit risk that one of the suppliers will not complete requested labor services.

12) The tangible computer readable storage medium of claim 8, wherein capacity in a labor category is determined by historical business transaction volume of a supplier with the enterprise during a time period multiplied by an adjustment factor that reflects future performance capacity of the supplier.

13) The tangible computer storage medium of claim 8 having instructions for causing the computer to further execute the method for, minimizing a number of the suppliers that collectively cover projected spending in multiple labor categories while (1) not exceeding individual supplier's capacities in any of the multiple labor categories determined from the historical data; and (2) not exceeding a policy limit on a maximum percentage of total money spend in a category that is awarded to any individual supplier.

14) The tangible computer storage medium of claim 8 having instructions for causing the computer to further execute the method for, determining conditions under which the set of constraints will lead to at least one numerical solution having conditions under which there is indeed a subset of suppliers that satisfy all constraints on individual supplier capacities and enterprise policy limits.

15) A computer system, comprising:
a database that stores historical data of third-party suppliers; and
a processor that executes an instruction to:
analyze the historical data and identify a sub-set of the suppliers to perform labor services for the enterprise, wherein the analyzed historical data includes a number and skill capability of laborers available at each of the suppliers to perform labor services for the enterprise and a capacity of labor services that each of the suppliers can provide the enterprise.

16) The computer system of claim 15, wherein the computer further executes the instruction to control a procurement risk for the enterprise by determining a minimum number of the suppliers to perform the labor services.

17) The computer system of claim 15, wherein the computer further executes the instruction to consolidate the suppliers by examining the historical data that includes forecasted demand of work requested by the enterprise, suppliers excluded from provided the labor services, and amounts of supplier share in different categories of labor services.

18) The computer system of claim 15, wherein the computer further executes the instruction to select a minimum number of the suppliers to perform the third-party labor services at a lowest cost.

19) The computer system of claim 15, wherein the computer further executes the instruction to select a minimum number of the suppliers to perform sufficient labor to complete tasks for the enterprise in each of the different labor categories.

20) The computer system of claim 15, wherein the computer further executes the instruction to recommend a distribution of the labor services to multiple suppliers to ensure that the multiple suppliers can complete the requested labor services.
